(19) United States
(12) Patent Application Publication
(10) Pub. No.: US 2014/0323606 A1
(43) Pub. Date: Oct. 30, 2014

(54) RUBBER-MODIFIED FLAME-RETARDANT MOULDING COMPOSITIONS AND PRODUCTION THEREOF

(71) Applicants: Matthias Mueller, Pfungstadt (DE); Norbert Guentherberg, Speyer (DE); Guenter Kehr, Ludwigshafen (DE); Norbert Niessner, Friedelsheim (DE)

(72) Inventors: Matthias Mueller, Pfungstadt (DE); Norbert Guentherberg, Speyer (DE); Guenter Kehr, Ludwigshafen (DE); Norbert Niessner, Friedelsheim (DE)

(73) Assignee: BASF SE, (DE)

(21) Appl. No.: 13/992,538

(22) PCT Filed: Dec. 15, 2011
(86) PCT No.: PCT/EP2011/072881

§ 371 Date: Sep. 18, 2013

(30) Foreign Application Priority Data
Dec. 16, 2010 (EP) 10195400.6

(51) Int. Cl. C08L 9/06; C08J 9/00

(52) U.S. Cl. CPC C08L 9/06; C08J 9/0061; C08L 2201/02; C08L 2203/14; C08L 2203/12
USPC 521/139; 524/127

(57) ABSTRACT

The invention relates to thermoplastic moulding compositions comprising A) between 55 to 98% in weight of at least one vinyl aromatic copolymer modified with a particulate graft rubber, B) between 1 to 44% in weight of a flame retardant comprising B1) an expandable graphite, B2) a flame-retardant compound comprising phosphorus, and B3) a fluorine-containing polymer, C) between 1 to 20% in weight of a non-particulate-forming rubber comprising polar groups, and D) between 0 to 40% in weight of additional additives, where the weight percentages are respectively based on the total weight of components A) to D), and said percentages add up to a total of 100% in weight, and the polybutadiene content is between 0 to 11I % in weight.

The invention relates to flame-retardant thermoplastic molding compositions which comprise several flame-retardant components, as well as to processes for the production thereof and the use thereof.

These thermoplastic molding compositions comprise:
A) from 55 to 98% by weight of at least one vinylaromatic copolymer impact-modified with a particulate graft rubber,
B) from 1 to 44% by weight of a flame retardant comprising
   B1) an expandable graphite,
   B2) a flame-retardant compound comprising phosphorus, and
   B3) a fluorine-containing polymer,
C) from 1 to 20% by weight of a non-particulate rubber comprising polar groups, and
D) from 0 to 40% by weight of further additives,
   where each of the percentages by weight is based on the total weight of components A) to D), and these percentages give a total of 100% by weight. The polybutadiene content is to be from 0 to 11% by weight.

The present invention further relates to a process for producing molding compositions of this type, to the use of molding compositions of this type for producing moldings, fibers, foams, and foils, and also to the resultant moldings, fibers, foams, and foils.

The use of expandable graphite as flame retardant in polystyrene (“PS”) or in impact-modified polystyrene (“HIPS”) is known by way of example from WO 2003/046071. In addition, according to said specification, amounts of from 2 to 11%, calculated as halogen, of a halogen-containing compound are needed as further flame-retardant component.

However, it is desirable to minimize the use of halogen-containing flame retardants, by way of example for toxicological reasons.

WO 2000/34367 and WO 2000/34342 disclose halogen-free flame-retardant styrene polymers which comprise expandable graphite and a phosphorus compound as flame-retardant components. However, molding compositions based on styrene polymers provided with this type of flame retardancy are unsatisfactory because they produce flaming drops in the event of a fire.

WO 2005/103136 discloses flame-retardant styrene polymers which comprise not only expandable graphite and a phosphorus compound but also a further coadditive which is intended to suppress migration of the phosphorus-containing flame retardant to the surface of the polymer. Polycarbonate is explicitly mentioned as coadditive.

KR10-1996-0001006 discloses flame-retardant polystyrene where the flame-retardant components comprise expandable graphite, a phosphorus compound, and Teflon. The average particle size of the expandable graphite is in this case 5 μm. The amounts used of the Teflon, which was added as antidrip agent, are from 1 to 5 percent by weight. The resultant halogen-free flame-retardant molding compositions have good heat resistance and impact resistance.

WO2009/007358 describes acrylonitrile-styrene-acrylate polymers (“ASA”) and acrylonitrile-butadiene-styrene polymers (“ABS”) which have been equipped with a flame-retardant system comprising expandable graphite, a phosphorus compound, and Teflon, and which also comprise linear styrene-butadiene block copolymers.

WO2010/003891 describes provision of flame-retardant molding compositions which are based on vinylaromatic copolymers impact-modified with particulate graft rubbers, in particular on ASA and/or on ABS, and which, when compared with known molding compositions, possess an improved combination of flame-retardant, mechanical, and rheological properties. However, the ABS-based molding compositions described in that document retain an unpleasant intrinsic odor.

An object on which the present invention was based was to eliminate the abovementioned disadvantages, and in particular to provide flame-retardant molding compositions which are based on vinylaromatic copolymers impact-modified with particulate graft rubbers, in particular on ASA and/or on ABS, and which, when compared with known molding compositions, exhibit an improvement in intrinsic odor.

Accordingly, the molding compositions defined in the introduction have been discovered, and have from 0 to 11% by weight polybutadiene content (based on the total weight of the molding compositions).

The flame-retardant molding compositions of the invention, based on vinylaromatic copolymers impact-modified with particulate graft rubbers, exhibit a marked reduction in intrinsic odor, when compared with known molding compositions.

The molding compositions of the invention, and also the processes and products of the invention, are described hereinafter.

The molding compositions of the invention comprise (or consist of) the following components:
A) from 55 to 98% by weight, preferably from 57 to 92% by weight, particularly preferably from 60 to 85% by weight, of component A,
B) from 1 to 44% by weight, preferably from 5 to 40% by weight, particularly preferably from 10 to 35% by weight, of component B,
C) from 1 to 20% by weight, preferably from 3 to 18% by weight, particularly preferably from 5 to 15% by weight, of component C, and
D) from 0 to 40% by weight, preferably from 0 to 30% by weight, particularly preferably from 0 to 25% by weight, of component D,
   where each of the percentages by weight is based on the total weight of components A) to D), and these percentages give a total of 100% by weight, and the polybutadiene content is from 0 to 11% by weight. In another embodiment, the polybutadiene content is from 3 to 10.5% by weight, preferably from 5 to 10% by weight.

In another preferred embodiment, the polybutadiene content is 0% by weight, i.e. particulate graft rubbers are used which have a rubber core based on monomers other than butadiene, in particular based on meth(acrylates), preferably on acrylates, particularly preferably on butyl acrylate.

Flame-retardant component B) in particular comprises the following constituents:
B1) from 20 to 79.99% by weight, preferably from 30 to 69.9% by weight, particularly preferably from 40 to 59.5% by weight, of component B1),
B2) from 20 to 79.99% by weight, preferably from 30 to 69.9% by weight, particularly preferably from 40 to 59.5% by weight, of component B2), and
B3) from 0.01 to 4% by weight, preferably from 0.1 to 3% by weight, particularly preferably from 0.5 to 2% by weight, of component B3),
   where each of the percentages by weight is based on the total weight of components B1) to B3), and these percentages give a total of 100% by weight.

In one specific embodiment of the invention, the molding composition comprises (or consists of):
A) from 60 to 85% by weight of component A,
B) from 10 to 35% by weight of component B,
C) from 5 to 15% by weight of component C, and
D) from 0 to 25% by weight of component D.

Flame retardant component B) may in this case preferably comprise the following constituents:
B1) from 40 to 59.5% by weight of component B1),
B2) from 40 to 59.5% by weight of component B2),
B3) from 0.01 to 4% by weight of component B3),
   where each of the percentages by weight of component B is based on the total weight of components B1) to B3), and together these percentages make 100% by weight, with the weight percentages of the molding composition (overall) being based in each case on the total weight of components A) to D) and together making 100% by weight. The polybutadiene content of the molding composition (overall) is to be from 0 to 11% by weight.

Often employed in the compositions are from 5 to 15% by weight of component C (such as ethylene-methacrylate copolymer (e.g. Elvaloy® 1330 EAC)), and from 0 to 25% by weight of component D (such as commercial carbon black).

### Regarding Component A):

In principle, any of the vinylaromatic copolymers impact-modified with a particulate graft rubber is suitable as component A. Said vinylaromatic copolymers impact-modified with a particulate graft rubber and production of same are known to the person skilled in the art, are described in the literature (for example in A. Echte, Handbuch der technischen Polymerchemie [Handbook of industrial polymer chemistry], VCH Verlagsgesellschaft, Weinheim, 1993; and Saechtling, Kunststoff Taschenbuch [Plastics handbook], Carl Hanser Verlag, Munich, 29th edition, 2004), and are frequently commercially available.

Preferred components A) comprise, as rubber phase, a particulate graft rubber, and, as thermoplastic hard phase, copolymers made of vinylaromatic monomers and of vinyl cyanides (SAN), in particular made of α-methylstyrene and acrylonitrile, particularly preferably made of styrene and acrylonitrile.

Component A) generally comprises from 15 to 60% by weight, preferably from 25 to 55% by weight, in particular from 30 to 50% by weight, of particulate graft rubber, and from 40 to 85% by weight, preferably from 45 to 75% by weight, in particular from 50 to 70% by weight, of vinylaromatic copolymers, where each of the percentages by weight is based on the total weight of particulate graft rubber and of vinylaromatic copolymer, and these give a total of 100% by weight.

It is preferable that the SAN used, impact-modified with a particulate graft rubber, comprises acrylonitrile-styrene-acrylate polymers (“ASA”) and/or acrylonitrile-butadiene-styrene polymers (“ABS”), or else (meth)acrylate-acrylonitrile-butadiene-styrene polymers (“MABS”, transparent ABS), or else blends of SAN, ABS, ASA and MABS with other thermoplastics, such as polycarbonate, polyamide, polyethylene terephthalate, polybutylene terephthalate, polyvinyl chloride, or polyolefins, very particularly preferably with polycarbonate.

ASA polymers are generally SAN polymers impact-modified with a particulate graft rubber, where elastomeric graft copolymers of vinylaromatic compounds, in particular of styrene, and of vinyl cyanides, in particular of acrylonitrile, are present on polyalkyl acrylate rubbers in a copolymer matrix made in particular of styrene, and/or α-methylstyrene, and acrylonitrile. ASA polymers and production of same are known to the person skilled in the art and described in the literature, for example in DIN EN ISO 6402-1 DE of February 2003, WO 2002/00745, WO 2000/11080, EP-A 450 485, and WO 2007/031445.

ABS polymers are generally impact-modified SAN polymers where diene polymers, in particular 1,3-polybutadiene, are present in a copolymer matrix made in particular of styrene, and/or α-methylstyrene, and acrylonitrile. ABS polymers and production of same are known to the person skilled in the art and described in the literature, for example in DIN EN ISO 2580-1 DE of February 2003, WO 2002/00745, and WO 2008/020012.

### Regarding Component B):

In the invention, the thermoplastic molding compositions comprise, as component B), a flame-retardant mixture comprising (or consisting of):

B1) expandable graphite,
B2) a flame-retardant compound comprising phosphorus, and
B3) a fluorine-containing polymer.

The molding compositions of the invention comprise, as component B1), expandable graphite known to the person skilled in the art and described in the literature (heat-expandable graphite). This generally derives from natural or synthetic graphite.

The expandable graphite is obtainable by way of example via oxidation of natural and/or synthetic graphite. The oxidants used can comprise H₂O₂ or nitric acid in sulfuric acid. The expandable graphite can also be produced via reduction, e.g. using sodium naphthalenide in an aprotic organic solvent. The layer-lattice structure of graphite renders it capable of forming specific types of intercalation compounds. In these intercalation compounds, foreign atoms or foreign molecules have been absorbed, sometimes in stoichiometric ratios, into the spaces between the carbon atoms. The surface of the expandable graphite can have been coated with a coating composition, for example with silane sizes known to the person skilled in the art, in order to improve compatibility with respect to the matrix of the thermoplastic.

In the event that the expandable graphite has been obtained by the abovementioned oxidation method, it can be necessary to add an alkaline compound, since otherwise the expandable graphite can (by virtue of the acid comprised) cause corrosion of the molding compositions and/or of the storage and production apparatus used for such molding compositions. In particular, amounts of up to 10% by weight, preferably up to 5% by weight (based on 100% by weight of B1) of alkali compounds, and also Mg(OH)₂ or Al hydroxides, can be added. Mixing advantageously takes place before the components are compounded.

The thermal expansion (specific volume change) of the expandable graphite on rapid heating from room temperature to 800° C. (in the direction of the c axis of the crystal) is preferably at least 100 ml/g, preferably at least 110 ml/g.

An essential factor for suitability as flame retardant is that the expandable graphite does not expand to any great extent at temperatures below 270° C., preferably below 280° C. The person skilled in the art understands this to mean that the volume expansion of the expandable graphite at the temperatures mentioned is less than 20% over a period of 10 min.

The coefficient of expansion (as specific core variable) generally means the difference between the specific volume (ml/g) after heating and the specific volume at room temperature of 20° C. The following specification is usually used to measure this: a quartz container is heated to 1000° C. in an electric furnace. 2 g of the expandable graphite are rapidly placed in the quartz container, and this is placed for 10 seconds in the furnace. The weight of 100 ml of the expanded graphite is measured in order to determine the “loosened apparent specific gravity”. The reciprocal is then the specific volume at this temperature. The specific volume at room temperature is correspondingly measured at 20° C. (Coefficient of expansion=specific volume after heating−specific volume at 20° C.)

The average particle size D50 of the expandable graphite is intended to be preferably from 10 μm to 1000 μm, with preference from 30 μm to 850 μm, and with particular preference from 200 μm to 700 μm. If the average particle sizes are lower, the result is generally insufficient flame-retardant action; if they are higher, the usual result is an adverse effect on the mechanical properties of the thermoplastic molding compositions.

The average particle size, and the particle size distribution, of the expandable graphite B1) can be determined from the cumulative volume distribution. The average particle sizes are always the volume-average particle sizes, as determined on the dry powder by means of laser light scattering in a Malvern Mastersizer 2000. Laser light scattering provides the cumulative distribution of the particle diameter of a specimen. From this it is possible to calculate the percentage of the particles with diameter equal to or smaller than a certain size. The average particle diameter, also termed the D₅₀ value of the cumulative volume distribution, is defined here as that particle diameter for which the diameter of 50% by weight of the particles is smaller than the diameter corresponding to the D₅₀ value. The diameter of 50% by weight of the particles is then likewise greater than the D₅₀ value.

The density of the expandable graphite is usually in the range from 0.4 to 2 g/cm³.

The phosphorus-containing compounds of component B2) are organic and inorganic compounds which comprise phosphorus, where the phosphorus has a valence state of from −3 to +5. For the purposes of the invention the valence state is the oxidation state as given in Lehrbuch der Anorganischen Chemie [Textbook of inorganic chemistry], by A. F. Hollemann and E. Wiberg, Walter de Gruyter & Co. (1964, 57th to 70th edition), pages 166-177. Phosphorus compounds of the valence states from −3 to +5 derive from phosphine (−3), diphosphine (−2), phosphine oxide (−1), elemental phosphorus (+0), hypophosphorous acid (+1), phosphorous acid (+3), hypodiphosphoric acid (+4) and phosphoric acid (+5).

Only a few examples will be mentioned from the large number of phosphorus-containing compounds suitable as component B2), in particular the inorganic or organic phosphates, phosphites, phosphonates, phosphate esters, red phosphorus, and triphenylphosphine oxide. Examples of phosphorus compounds of the phosphine class, which have the valence state −3, are aromatic phosphines, such as triphenylphosphine, tritolylphosphine, trinonylphosphine, trinaphthylphosphine and trisnonylphenylphosphine, inter alia. Triphenylphosphine is particularly suitable.

Examples of phosphorus compounds of the diphosphine class, having the valence state −2, are tetraphenyldiphosphine and tetranaphthyldiphosphine, inter alia. Tetranaphthyldiphosphine is particularly suitable. Phosphorus compounds of the valence state −1 derive from phosphine oxide. Phosphine oxides of the general formula (I) are suitable compounds

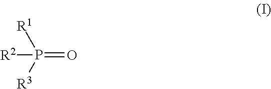

where R¹, R² and R³ in formula I are identical or different alkyl, aryl, alkylaryl or cycloalkyl groups having from 8 to 40 carbon atoms.

Examples of phosphine oxides are triphenylphosphine oxide, tritolylphosphine oxide, trisnonylphenylphosphine oxide, tricyclohexylphosphine oxide, tris(n-butyl)phosphine oxide, tris(n-hexyl)phosphine oxide, tris(n-octyl)phosphine oxide, tris(cyanoethyl)phosphine oxide, benzylbis(cyclohexyl)phosphine oxide, benzylbisphenylphosphine oxide and phenylbis(n-hexyl)phosphine oxide.

Other preferred compounds are oxidized reaction products of phosphine with aldehydes, in particular of tert-butylphosphine with glyoxal. Particular preference is given to the use of triphenylphosphine oxide, tricyclohexylphosphine oxide, tris(n-octyl)phosphine oxide or tris(cyanoethyl)phosphine oxide, in particular triphenylphosphine oxide. Other suitable compounds are triphenylphosphine sulfide and its derivatives as described above for phosphine oxides.

Phosphorus in the valence state +0 is elemental phosphorus. Red and black phosphorus can be used, and red phosphorus is preferred, particularly the surface-coated red phosphorus known to the person skilled in the art and described in the literature and commercially available as flame retardant for polymers.

Examples of phosphorus compounds of the oxidation state +1 are hypophosphites of purely organic type, e.g. organic hypophosphites such as cellulose hypophosphite esters and esters of hypophosphorous acids with diols, e.g. that of 1,10-dodecyldiol. It is also possible to use substituted phosphinic acids and anhydrides of these, e.g. diphenylphosphinic acid. Other possible compounds are diphenylphosphinic acid, di-p-tolylphosphinic acid and dicresylphosphinic anhydride. Compounds such as the bis(diphenylphosphinic) esters of hydroquinone, ethylene glycol and propylene glycol, inter alia, may also be used.

Other suitable compounds are aryl(alkyl)phosphinamides, such as the dimethylamide of diphenylphosphinic acid, and sulfonamidoaryl(alkyl)phosphinic acid derivatives, such as p-tolylsulfonamidodiphenylphosphinic acid. Preference is given to use of the bis(diphenylphosphinic) ester of hydroquinone or of ethylene glycol, or bis(diphenylphosphinate) of hydroquinone.

Phosphorus compounds of the oxidation state +3 derive from phosphorous acid. Suitable compounds are cyclic phosphonates which derive from pentaerythritol, neopentyl glycol or pyrocatechol, for example compounds of the formula (II)

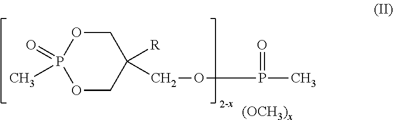

where R is a C₁ to C₄-alkyl radical, preferably a methyl radical, and x=0 or 1 (Amgard® P 45 from Albright & Wilson).

Phosphorus of the valence state +3 is also present in triaryl(alkyl)phosphites, such as triphenyl phosphite, tris(4-decylphenyl)phosphite, tris(2,4-di-tert-butylphenyl)phosphite and phenyl didecyl phosphite, inter alia. It is also possible, however, to use diphosphites, such as propylene glycol 1,2-bis(diphosphite) or cyclic phosphites which derive from pentaerythritol, from neopentyl glycol or from pyrocatechol.

Particular preference is given to neopentyl glycol methylphosphonate and neopentyl glycol methyl phosphite, and also to pentaerythritol dimethyldiphosphonate and dimethyl pentaerythritol diphosphite.

Phosphorus compounds of oxidation state +4 which may be used are particularly hypodiphosphates, such as tetraphenyl hypodiphosphate and bisneopentyl hypodiphosphate.

Phosphorus compounds of oxidation state +5 which may be used are particularly alkyl- and aryl-substituted phosphates. Examples of these are phenyl bisdodecyl phosphate, phenyl ethyl hydrogenphosphate, phenyl bis(3,5,5-trimethylhexyl)phosphate, ethyl diphenyl phosphate, 2-ethylhexyl ditolyl phosphate, diphenyl hydrogenphosphate, bis(2-ethylhexyl) p-tolyl phosphate, tritolyl phosphate, bis(2-ethylhexyl) phenyl phosphate, di(nonyl) phenyl phosphate, phenyl methyl hydrogenphosphate, didodecyl p-tolyl phosphate, p-tolylbis(2,5,5-trimethylhexyl)phosphate and 2-ethylhexyl diphenyl phosphate. Particularly suitable phosphorus compounds are those in which each radical is aryloxy. Very particularly suitable compounds are triphenyl phosphate and resorcinol bis(diphenyl phosphate) and its ring-substituted derivatives of the general formula (III) (RDPs):

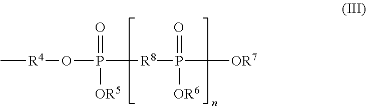

in which the definitions of the substituents in formula III are as follows:
R⁴-R⁷ are aromatic radicals having from 6 to 20 carbon atoms, preferably phenyl radicals, which may have substitution by alkyl groups having from 1 to 4 carbon atoms, preferably methyl,
R⁸ is a bivalent phenol radical, preferably

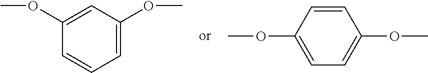

and n has an average value of from 0.1 to 100, preferably from 0.5 to 50, in particular from 0.8 to 10 and very particularly from 1 to 5.

Due to the process used for their manufacture, RPD products available commercially under the trade name Fyroflex® or Fyrol® RDP (Akzo) and also CR 733-S (Daihachi) are mixtures of about 85% of RDP (n=1) with about 2.5% of triphenyl phosphate and also about 12.5% of oligomeric fractions in which the degree of oligomerization is mostly less than 10.

It is also possible to use cyclic phosphates. Of these, diphenyl pentaerythritol diphosphate and phenyl neopentyl phosphate are particularly suitable. Besides the low-molecular-weight phosphorus compounds mentioned above, it is also possible to use oligomeric or polymeric phosphorus compounds. Polymeric, halogen-free organic phosphorus compounds of this type with phosphorus in the polymer chain are produced, for example, in the preparation of pentacyclic unsaturated phosphine dihalides, as described, for example, in DE-A 20 36 173. The molecular weight of the polyphospholine oxides, measured by vapor pressure osmometry in dimethylformamide, should be in the range from 500 to 7000, preferably from 700 to 2000. The phosphorus atom here has the oxidation state −1.

It is also possible to use inorganic coordination polymers of aryl(alkyl)phosphinic acids, such as poly-β-sodium(I) methylphenylphosphinate. Their preparation is given in DE-A 31 40 520. Phosphorus has the oxidation number +1. Halogen-free polymeric phosphorus compounds of this type may also be produced by the reaction of a phosphonic acid chloride, such as phenyl-, methyl-, propyl-, styryl- or vinylphosphonyl dichloride, with dihydric phenols, such as hydroquinone, resorcinol, 2,3,5-trimethylhydroquinone, bisphenol A, or tetramethylbisphenol A.

Other halogen-free polymeric phosphorus compounds which may be present in the inventive molding compositions are prepared by reacting phosphorus oxytrichloride or phosphoric ester dichlorides with a mixture of mono-, di- or trihydric phenols and other compounds carrying hydroxy groups (cf. Houben-Weyl-Müller, Thieme-Verlag, Stuttgart, Germany, Organische Phosphorverbindungen [Organic phosphorus compounds] Part II (1963)). It is also possible to produce polymeric phosphonates via transesterification reactions of phosphonic esters with dihydric phenols (cf. DE-A 29 25 208) or via reactions of phosphonic esters with diamines, or with diamides or hydrazides (cf. U.S. Pat. No. 4,403,075). However, the inorganic compound poly(ammonium phosphate) may also be used.

It is also possible to use oligomeric pentaerythritol phosphites, oligomeric pentaerythritol phosphates, and oligomeric pentaerythritol phosphonates according to EP-A 008 486, e.g. Mobil Antiblaze® 19 (registered trade mark of Mobil Oil), e.g. according to formulae (IV) and (V):

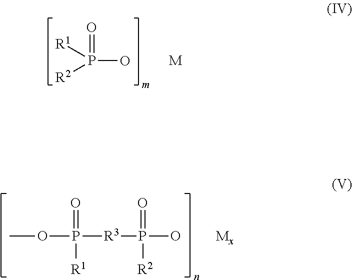

where the definitions of the substituents in the formulae IV and V are as follows:
R¹ and R² are hydrogen, C₁ to C₆-alkyl, which optionally comprises a hydroxy group, preferably C₁ to C₄-alkyl, linear or branched, e.g. methyl, ethyl, n-propyl, isopropyl, n-butyl, tert-butyl, n-pentyl; phenyl; where preferably at least one radical R¹ or R², and in particular R¹ and R², is/are hydrogen;
R³ is C₁ to C₁₀-alkylene, linear or branched, e.g. methylene, ethylene, n-propylene, isopropylene, n-butylene, tert-butylene, n-pentylene, n-octylene, n-dodecylene; arylene, e.g. phenylene, naphthylene; alkylarylene, e.g. methylphenylene, ethylphenylene, tert-butylphenylene, methylnaphthylene, ethylnaphthylene, tert-butylnaphthylene; arylalkylene, e.g. phenylmethylene, phenylethylene, phenylpropylene, phenylbutylene;
M is an alkaline earth metal or alkali metal, Al, Zn, Fe, boron;
m is a whole number from 1 to 3;
n is a whole number of 1 and 3, and
x is 1 or 2.

Particular preference is given to compounds of the formula IV in which R¹ and R² are hydrogen, where M is preferably Ca, Zn, or Al, and very particular preference is given to the compound calcium phosphinate. Products of this type are commercially available, e.g. as calcium phosphinate.

Examples of suitable salts of the formula (IV) or (V), in which only one radical R¹ or R² is hydrogen, are salts of phenylphosphinic acid, its Na and/or Ca salts being preferred.

Further preference is given to salts which have an alkyl radical R¹ and/or R² comprising hydroxy groups. By way of example, these are obtainable by hydroxymethylation. Preferred compounds are Ca, Zn, and Al salts.

The average particle size D₅₀ of component B2) (measured by the method described above in relation to particle size determination for component B1) is preferably smaller than 10 μm, preferably smaller than 7 μm, and in particular smaller than 5 μm.

The D₁₀ value is preferably smaller than 4 μm, in particular 3 μm, and very particularly preferably smaller than 2 μm. Preferred D₉₀ values are smaller than 40 μm and in particular smaller than 30 μm, and very particularly preferably smaller than 20 μm.

Further preference is given to phosphorus compounds of the general formula (VI):

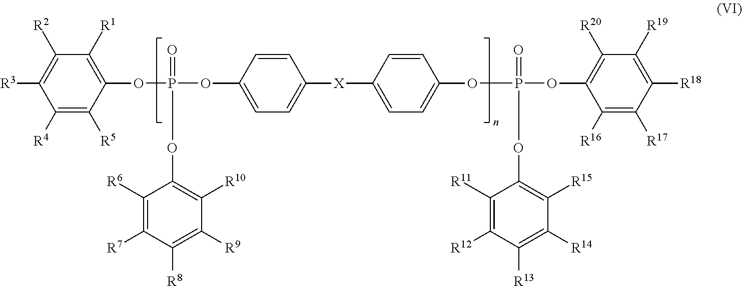

where the definitions of the substituents in formula (VI) are as follows:
R¹ to R²⁰, independently of one another, are hydrogen, or a linear or branched alkyl group up to 6 carbon atoms
n has an average value of from 0.5 to 50, and
X is a single bond, C═O, S, SO₂, or C(CH₃)₂

Preferred compounds B2) are those of formula (VI), in which R¹ to R²⁰, independently of one another, are hydrogen and/or a methyl radical. If R¹ to R²⁰, independently of one another, are a methyl radical, preference is given to those compounds in which the radicals R¹, R⁵, R⁶, R¹⁰, R¹¹, R¹⁵, R¹⁶, R²⁰ in ortho-position with respect to the oxygen of the phosphate group are at least one methyl radical.

Preference is also given to compounds B2) in which one methyl group is present per aromatic ring, preferably in ortho-position, and the other radicals are hydrogen. Particularly preferred substituents are SO₂ and S, and C(CH₃)₂ is very particularly preferred for X in the above formula (VI). The average value of n in formula (VI) above is preferably from 0.5 to 5, in particular from 0.7 to 2, and in particular 1.

The statement of n as an average value is a consequence of the preparation process for the compounds listed above, the degree of oligomerization mostly being smaller than 10 and the content of triphenyl phosphate present being small (mostly <5% by weight), there being a difference here from batch to batch. Such compounds B2) are commercially available as CR-741 from Daihachi.

A very particularly preferred embodiment of the invention has proven to be the use of a mixture composed of red phosphorus and of at least one of the phosphorus compounds described above other than red phosphorus as component B2). One mixture particularly preferred as component B2) is composed of red phosphorus and of at least one inorganic or organic phosphate, phosphite, phosphonate, phosphate ester, or triphenylphosphine oxide. Particularly advantageous mixtures are those made of red phosphorus and ammonium polyphosphate, of red phosphorus and bisphenol A bis(diphenyl phosphate), or of red phosphorus and triphenyl phosphate. One mixture very particularly preferred as component B2) comprises red phosphorus and ammonium polyphosphate. One further mixture very particularly preferred as component B2) is composed of red phosphorus and ammonium polyphosphate and triphenyl phosphate.

If component B2) used comprises the abovementioned mixture made of red phosphorus and of at least one of the phosphorus compounds described above that differ from red phosphorus, these molding compositions of the invention exhibit an improved combination of flame-retardant, mechanical, and rheological properties, and also in particular high heat resistance (Vicat temperature).

If component B2) used comprises the abovementioned mixtures made of red phosphorus and of at least one of the phosphorus compounds described above that differ from red phosphorus, component B2) generally comprises from 10 to 90% by weight, preferably from 20 to 80% by weight, particularly preferably from 30 to 70% by weight, of red phosphorus, and from 10 to 90% by weight, preferably from 20 to 80% by weight, particularly preferably from 30 to 70% by weight, of at least one of the phosphorus compounds described above that differ from red phosphorus, where the percentages by weight of red phosphorus and of the at least one phosphorus compound described above and differing from red phosphorus are always based on the total weight of component B2) and these give a total of 100% by weight.

The molding compositions comprise a fluorine-containing polymer as component B3). Preference is given to fluorine-containing ethylene polymers. These involve polymers of ethylene having from 55 to 76% by weight fluorine content, preferably from 70 to 76% by weight.

Examples here are polytetrafluoroethylene (PTFE), tetrafluoroethylene-hexafluoropropylene copolymers, or tetrafluoroethylene copolymers having relatively small proportions (generally up to 50% by weight) of copolymerizable ethylenically unsaturated monomers. These are described by way of example by Schildknecht in “Vinyl and Related Polymers”, Wiley-Verlag, 1952, pp. 484 to 494, and by Wall in “Fluorpolymers” [fluoropolymers] (Wiley Interscience, 1972).

Said fluorine-containing ethylene polymers generally have homogeneous distribution in the molding compositions and preferably have an average particle size D₅₀ in the range from 0.05 to 10 μm, in particular from 0.1 to 5 μm. These small particle sizes can particularly preferably be achieved via use of aqueous dispersions of fluorine-containing ethylene polymers and incorporation of these into a polymer melt.

In one preferred embodiment of the invention, the proportion by weight of the fluorine-containing polymer B3), based on the total weight of components A) to D), is from 0.01 to 0.5% by weight, preferably from 0.1 to 0.45% by weight, particularly preferably from 0.2 to 0.4% by weight.

### Regarding Component C):

A suitable component C) is in principle any of the non-particulate rubbers known to the person skilled in the art and described in the literature and comprising polar groups. Examples of suitable components C) that can be used in the invention are non-particulate rubbers which comprise polar groups and which have been crosslinked. However, preferred components C) are uncrosslinked rubbers comprising polar groups, in particular linear rubbers comprising polar groups.

For the purposes of this invention, polar groups are preferably O- and/or N-containing functional groups, in particular hydroxy, alkoxy, amino, imino, alkoxycarbonyl, carboxamide, and/or carboxy groups, and particularly preferably acrylic-acid-derived or maleic-acid-derived acid or ester groups.

Ethylene-acrylate rubbers are particularly suitable as component C).

Preferred ethylene-acrylate rubbers are copolymers made of ethylene and methyl acrylate, or in particular terpolymers made of ethylene, methyl acrylate, and of an unsaturated carboxylic acid; A suitable unsaturated carboxylic acid for producing said terpolymers is maleic acid or hemiesters thereof, but preferably acrylic acid.

The ethylene-acrylate rubbers can also be used as component C) in a form by way of example crosslinked with diamines, in particular hexane-1,6-diamine or 4,4′-methylenedianiline. For the purposes of the present invention, particularly suitable ethylene-acrylate rubbers are available commercially as Elvaloy® 1330 EAC (DuPont).

### Regarding Component D):

The thermoplastic molding compositions can comprise, as component D), one or more additives differing from components A), B), and C). In principle, any of the additives that are conventional in plastics and described in the literature and known to the person skilled in the art is suitable. For the purposes of the present invention, examples of additives conventional in plastics are stabilizers and oxidation retarders, agents to counteract decomposition by heat and decomposition by ultraviolet light, lubricants and mold-release agents, dyes and pigments, and plasticizers, and also fibers, such as glass fibers or carbon fibers.

Examples of oxidation retarders and heat stabilizers which can be added to the thermoplastic molding composition of the invention are halides of metals of group I of the periodic table, e.g. sodium halides, potassium halides, and lithium halides. It is also possible to use zinc fluoride and zinc chloride. Other compounds that can be used are sterically hindered phenols, hydroquinones, substituted members of this group, secondary aromatic amines, optionally in conjunction with phosphorus-containing acids or, respectively, salts of these, and mixtures of said compounds, preferably in concentrations of up to 1% by weight, based on the weight of the thermoplastic molding compositions.

Examples of UV stabilizers are various substituted resorcinols, salicylates, benzotriazoles, and benzophenones, the amounts generally used of which are up to 2% by weight, based on the weight of the thermoplastic molding compositions.

Lubricants and mold-release agents that can be added, generally in amounts up to 1% by weight, based on the weight of the thermoplastic molding compositions, are stearic acid, stearyl alcohol, alkyl stearates and stearamides, and also esters of pentaerythritol with long-chain fatty acids. It is also possible to use stearates of calcium, of zinc, or of aluminum, and also dialkyl ketones, e.g. distearyl ketone. Particularly suitable compounds in the invention are zinc stearate, magnesium stearate, and calcium stearate, and also N,N′-ethylenebisstearamide.

Glass fibers that can be used in the molding compositions of the invention are any of the glass fibers described in the literature and known to the person skilled in the art (see by way of example Milewski, J. V., Katz, H. S. “Handbook of Reinforcements for Plastics”, pp. 233 ff., Van Nostrand Reinholt Company Inc, 1987).

### Regarding the Production Processes:

The thermoplastic molding compositions of the invention can be produced by processes known per se, by mixing the starting components in conventional mixing apparatuses, such as screw-based extruders, Brabender mixers, or Banbury mixers, and then extruding same. After the extrusion, the extrudate can be cooled and comminuted. It is also possible to premix individual components and then to add the remaining starting materials individually and/or likewise in mixed form. The mixing temperatures are generally from 200 to 280° C.

In one preferred procedure, components A), B) except for B1), C), and optionally D) can be premixed in a first step. The premixed components can either be compounded and by way of example pelletized, or else can be mixed directly in the form of melt, for example in the same extruder, with component B1) in a subsequent, second step.

The flame-retardant molding compositions of the invention, based on the vinylaromatic copolymers impact-modified with particulate graft rubbers, have markedly reduced intrinsic odor when compared with known molding compositions.

The examples and patent claims provide further explanation of the invention.

### Regarding the Test Methods:

Notched impact resistance aₖ [kJ/m²]:

Notched impact resistance ak was determined to ISO 179 1eA(F) at 23° C.

Flowability MVR [ml/10 min]:

Melt volume rate MVR 200/5 to DIN EN ISO 1133 was determined as a measure of flowability.

Heat resistance, Vicat B, [° C.]:

Heat resistance was determined in the form of Vicat softening point on standard small specimens at a heating rate of 50 K/hour and with a force of 49.05 N to DIN 53460, method B.

Afterflame time t_{N} [s]:

In the fire test based on UL 94, vertical burning standard, the first afterflame time t1 was measured on specimens of thickness 1.6 mm after a first flame-application time of 10 seconds. The second afterflame time t2 was measured after a second flame-application time of 10 seconds directly following extinguishment of the flames. The sum of afterflame times t1 and t2 gives the afterflame time tN (the value stated in each case being the average value of afterflame times tN determined on two specimens).

### Odor Test:

The odor test used specimens of thickness 1.6 mm that were also used for the fire test. The specimens were placed in a 500 ml glass container with screw closure and stored at 60° C. for 24 h in the closed state. After cooling to room temperature, odor was evaluated on a scale of:
very poor (−−), poor (−), satisfactory (o), good (+), very good (++).

### Regarding the Starting Materials

Components or experiments with prefix “comp-” are not of the invention and serve for comparison.

### Polymer Component A):

Components A used comprised:
a-I: Terluran® HI10, from BASF SE, a commercially available acrylonitrile-butadiene-styrene copolymer (ABS) comprising a styrene-acrylonitrile copolymer hard phase and a particulate butadiene graft rubber.
a-II: Luran S, from BASF SE, a commercially available butyl acrylate-styrene-acrylonitrile copolymer (ASA), comprising a styrene-acrylonitrile copolymer hard phase and a particulate butyl acrylate graft rubber.
a-III: A styrene-acrylonitrile copolymer (SAN) comprising 24% by weight of acrylonitrile and 78% by weight of styrene with intrinsic viscosity 64 ml/g.

### Flame-Retardant Component B):

Component B1) used comprised:
b1-I: Nord-Min® 503 expandable graphite from Nordmann, Rassmann, GmbH, with average particle size D₅₀ 465 μm, free expansion (beginning at about 300° C.) at least 150 ml/g, and bulk density 0.5 g/ml at 20° C.

Component B2) used comprised:
b2-I: Disflammol® TP, a triphenyl phosphate from Lanxess Aktiengesellschaft.
b2-II: Nord-Min® JLS, an ammonium polyphosphate from Nordmann, Rassmann, GmbH.
b2-III: Masteret 38450, a red phosphorus masterbatch from Italmatch Chemicals Spa.

Component B3) used comprised:
b3-I: TE-3893 polytetrafluoroethylene PTFE, Teflon® dispersion from C. H. Erbsloh, having 60% by weight PTFE content (based on the total weight of the dispersion).

### Rubber Component C):

Component C) used comprised:
c-I: A commercially available linear ethylene-methacrylate copolymer, Elvaloy® 1330 EAC, from DuPont.

### Further Additives D):

Component D) used comprised:
d-I: Black Pearls® 880, a commercially available carbon black from Cabot Corp.

### Production of the Molding Compositions and Moldings:

To determine the fire properties and odor properties mentioned in tables 1 and 2, components A) to D) (see table 1 for respective parts by weight) were homogenized in a DSM Midiextruder and, using an injection-molding attachment, at a melt temperature of 240° C. and a mold surface temperature of 80° C., extruded to give test specimens to UL 94, (“vertical burning standard”), of thickness 1.6 mm.

The main source of odor here can be attributed to interaction between the expandable graphite and the polybutadiene component from the ABS, and this is confirmed by the examples in the table.

TABLE 1
Constitution and properties of the molding
compositions (prefix comp.: for comparison)

| | Example | | | | | | |
|---|---|---|---|---|---|---|---|
| | comp. 1 | comp. 2 | comp. 3 | 1 | 2 | 3 | 4 |
| Constitution | | | | | | | |
| [pts. by weight | | | | | | | |
| (% by weight)] | | | | | | | |
| a-I | 54.6 | 49.6 | 44.6 | 39.6 | 34.6 | 29.6 | 0 |
| a-II | 0 | 5 | 10 | 15 | 20 | 25 | 54.6 |
| a-III | 16.7 | 16.7 | 16.7 | 16.7 | 16.7 | 16.7 | 16.7 |
| b1-I | 8 | 8 | 8 | 8 | 8 | 8 | 8 |
| b2-I | 4 | 4 | 4 | 4 | 4 | 4 | 4 |
| b2-II | 1 | 1 | 1 | 1 | 1 | 1 | 1 |
| b2-III | 4.5 | 4.5 | 4.5 | 4.5 | 4.5 | 4.5 | 4.5 |
| b3-I | 0.4 | 0.4 | 0.4 | 0.4 | 0.4 | 0.4 | 0.4 |
| c-I | 10 | 10 | 10 | 10 | 10 | 10 | 10 |
| d-I | 0.8 | 0.8 | 0.8 | 0.8 | 0.8 | 0.8 | 0.8 |
| Polybutadiene | 13.8 | 12.5 | 11.2 | 10.0 | 8.7 | 7.5 | 0 |
| content | | | | | | | |
| Properties | | | | | | | |
| Odor | −− | − | − | ∘ | + | ++ | ++ |
| evaluation | | | | | | | |
| Afterflame | 2.3 | 3.2 | 4.8 | 7.3 | 5.7 | 2.4 | 3.0 |
| time t_{N} [s] | | | | | | | |

TABLE 2
Constitution and properties of the molding
compositions (prefix comp.: for comparison)

| | Example | | | | | | |
|---|---|---|---|---|---|---|---|
| | comp. 1 | comp. 2 | 1 | 2 | 3 | 4 | 5 |
| Constitution | | | | | | | |
| [pts. by weight | | | | | | | |
| (% by weight)] | | | | | | | |
| a-I | 55 | 45 | 35 | 25 | 15 | 10 | 0 |
| a-II | 0 | 10 | 20 | 30 | 40 | 45 | 55 |
| a-III | 37 | 37 | 37 | 37 | 37 | 37 | 37 |
| b1-I | 8 | 8 | 8 | 8 | 8 | 8 | 8 |
| Polybutadiene | 13.9 | 11.3 | 8.8 | 6.3 | 3.8 | 2.5 | 0.0 |
| content | | | | | | | |
| Properties | | | | | | | |
| Odor evaluation | −− | − | + | ++ | ++ | ++ | ++ |

The examples show that when the intrinsic odor of the flame-retardant molding compositions of the invention, based on vinylaromatic copolymers impact-modified with particulate graft rubbers, is compared with that of known molding compositions it is markedly reduced, i.e. acceptable.

1. A thermoplastic molding composition comprising:
A) from 55 to 98% by weight of at least one vinylaromatic copolymer impact-modified with a particulate graft rubber,
B) from 1 to 44% by weight of a flame retardant comprising
B1) an expandable graphite,
B2) a flame-retardant compound comprising phosphorus, and
B3) a fluorine-containing polymer,
C) from 1 to 20% by weight of a non-particulate rubber comprising polar groups, and
D) from 0 to 40% by weight of further additives,
where each of the percentages by weight is based on the total weight of components A) to D), and these percentages give a total of 100% by weight, and the polybutadiene content is from 0 to 11% by weight.

2. The thermoplastic molding composition according to claim 1, which has from 3 to 10.5% by weight polybutadiene content.

3. The thermoplastic molding composition according to claim 1, which has from 5 to 10% by weight polybutadiene content.

4. The thermoplastic molding composition according to claim 1, which has a 0% by weight polybutadiene content, and wherein the particulate graft rubber comprises polymeth(acrylate).

5. The thermoplastic molding composition according to claim 1, which has a 0% by weight polybutadiene content, and wherein the particulate graft rubber comprises polyacrylate.

6. The thermoplastic molding composition according to claim 1, which has a 0% by weight polybutadiene content, and wherein the particulate graft rubber comprises polybutyl acrylate.

7. The thermoplastic molding composition according to claim 1, comprising an ethylene-acrylate rubber as component C).

8. The thermoplastic molding composition according to claim 1, comprising, as component A), acrylonitrile-styrene-acrylate polymers (“ASA”) and/or acrylonitrile-butadiene-styrene polymers (“ABS”).

9. The thermoplastic molding composition according to claim 1, comprising, as component B2), at least one compound selected from inorganic or organic phosphates, phosphites, phosphonates, phosphate esters, red phosphorus, and triphenylphosphine oxide.

10. The thermoplastic molding composition according to claim 1, comprising, as component B2), a mixture made of red phosphorus and of at least one inorganic or organic phosphate, phosphite, phosphonate, phosphate ester, or triphenylphosphine oxide.

11. The thermoplastic molding composition according to claim 1, comprising, as component B2), a mixture made of red phosphorus and ammonium polyphosphate.

12. The thermoplastic molding composition according to claim 1, comprising, as component B2), a mixture made of red phosphorus and ammonium polyphosphate and triphenyl phosphate.

13. The thermoplastic molding composition according to claim 1, comprising a fluorinated ethylene polymer as component B3).

14. The thermoplastic molding composition according to claim 1, comprising
from 20 to 79.99% by weight of component B1),
from 20 to 79.99% by weight of component B2), and
from 0.01 to 4% by weight of component B3),
where each of the percentages by weight is based on the total weight of components B1) to B3), and these percentages give a total of 100% by weight.

15. A process for producing the thermoplastic molding compositions according to claim 1, which comprises mixing, in the melt, components A), B), C), and, if present, D).

16. The use of the thermoplastic molding compositions according to claim 1 for producing fibers, foils, moldings, and foams.

17. A fiber, foil, molding, or foam obtainable from the thermoplastic molding compositions according to claim 1.
